(19) United States
(12) Patent Application Publication
(10) Pub. No.: US 2018/0311100 A1
(43) Pub. Date: Nov. 1, 2018

(54) COVERING DEVICE FOR AN INCUBATOR FOR NEWBORNS

(71) Applicant: CONSEILS, RECHERCHES ET DEVELOPPEMENT EN SANTE (CO. R.DE.S), Nancy (FR)

(72) Inventors: Sylvie VOIRIN, Tomblaine (FR); Jean Michel HASCOET, Lay Saint Christophe (FR)

(21) Appl. No.: 15/569,336

(22) PCT Filed: Apr. 11, 2016
(86) PCT No.: PCT/FR2016/050827

§ 371 Date: Oct. 25, 2017

(30) Foreign Application Priority Data
Apr. 28, 2015 (FR) 1553819

(51) Int. Cl. A61G 11/00

(52) U.S. Cl. CPC A61G 11/00

(57) ABSTRACT

The covering device for an incubator for newborns includes a longitudinal direction characterized in that one of its ends, in the longitudinal direction, has a width at least two times greater than its width at its opposite end. At least in the median part of its larger width, it is extended by a longitudinal flap.

The present invention relates to the field of hospital equipment for newborns. It more particularly relates to a covering device for incubators for newborns.

Newborns, and more particularly premature newborns and sick newborns, require special care. They are generally kept under surveillance in incubators, in an environment where the temperature and other physical data, such as hygrometry, are precisely controlled.

The incubators are generally transparent, as a result of which the brightness is a more difficult physical parameter to control.

Depending on the care units, the brightness may be too high, or on the contrary, too low. Indeed, the incubators are either completely concealed by covering devices, or left as is under the light in the room.

This may result in disruptions to visual development through excessive light stimulation or disturbances in the establishment of the nychthemeral rhythm essential for the establishment of physiological hormone cycles through sufficient light stimulation.

Furthermore, completely concealing the incubator causes more frequent manipulations of the environment during access to the child for care, which may increase the risk of secondary infections.

Caregiver monitoring requirements and the need to keep spontaneous visual contact for parent-child relationships also come into play in controlling brightness.

Technical solutions are already known, but they only partially resolve the problems posed.

For example, utility certificate TWM 455489 proposes a complete covering device in which an opening possibility is arranged on top. This device makes it possible to establish and provide visual contact between the caregiving staff and the newborn when the top is open, but on the one hand, not enough light is able to penetrate the incubator, and on the other hand, a spontaneous relationship between the parents and the child cannot be established. Patent application US 2006 0079730 proposes a similar solution with identical drawbacks.

Premature newborns are very sensitive to their environment. The hospital environment, despite careful care from the staff, may cause a lack of the stimulation necessary for development. This may include a lack of visual stimulation.

Thus, specific adapted visual stimulation may help them develop their visual function.

The present invention therefore aims to propose new means for resolving the drawbacks of the prior art. It more particularly aims to propose a covering device for an incubator for newborns including a longitudinal direction characterized in that one of its ends, in the longitudinal direction, has a width at least two times greater than its width at its opposite end; and in that at least in the median part of its larger width, it is extended by a longitudinal flap.

Other features and advantages of the present invention will appear upon reading the following detailed description, in reference to an example embodiment provided for information and non-limitingly.

This description will be easier to understand in reference to the appended drawings, in which:

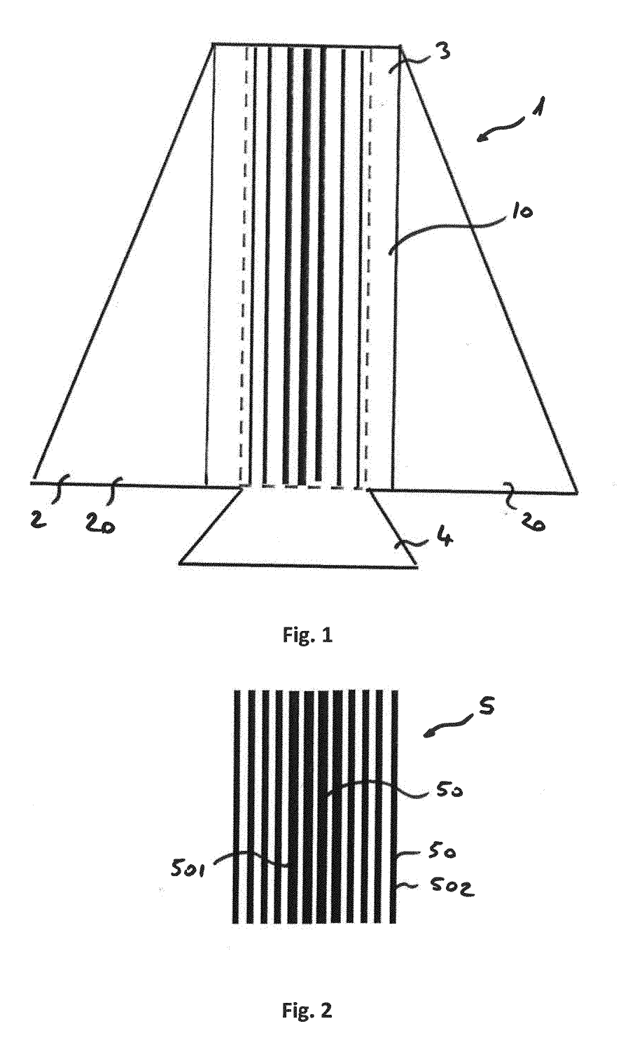

FIG. 1 schematically shows a covering device according to the invention;

FIG. 2 schematically shows a target device according to the invention;

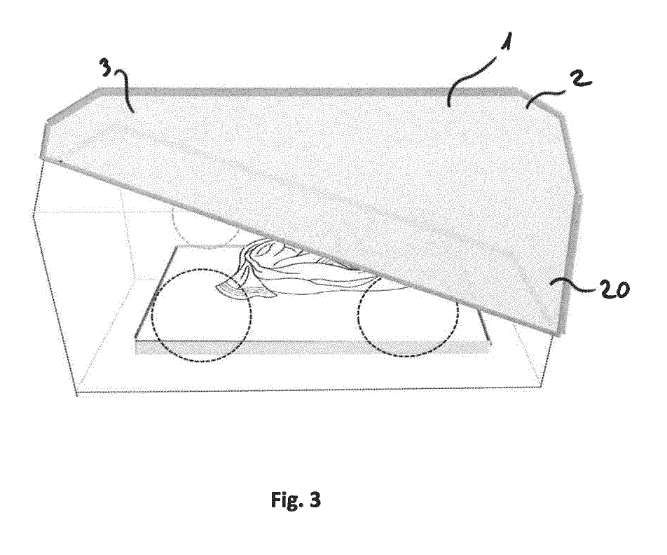

FIG. 3 schematically shows a view of the covering device arranged on an incubator.

Thus and as shown in FIGS. 1 to 3, the present invention first relates to a covering device 1 for an incubator for newborns including a longitudinal direction, characterized in that one of its ends 2, in the longitudinal direction, has a width at least twice the size of its width at its opposite end 3; and in that at least in the median part of its larger width, it is extended by a longitudinal flap 4.

The covering device 1 is generally arranged on top of an incubator with its widest end 2 arranged above the newborn's head. The largest width of the covering device 1 forms side flaps 20 falling on the sides of the incubator.

In this way, the covering device 1 can form a slipcover when it is arranged on top of an incubator.

The flaps 4 and 20 make it possible to protect the child from direct exposure to light while preventing him from being in total darkness. This access to indirect light facilitates the establishment of the nychthemeral rhythm, thus favoring the establishment of the endocrine cycles.

Furthermore, the child remaining accessible to outside view by the narrowest end 3 of the cover 1, caregivers can monitor his behavior, in addition to automated monitoring.

The narrowest end 3 of the covering device 1 can easily be folded for access to the opening of the incubator.

The parents have direct visual access to their child with no intermediate obstacles.

The covering device 1, respecting access to the side care portholes, reduces inappropriate and excessive manipulations.

Advantageously, the covering device 1 is symmetrical relative to a longitudinal plane.

This symmetry allows easy positioning on top of the incubator.

Preferably, the covering device 1 includes a rectangular median strip 10, laterally extended at the widest end by side flaps 20 extended at least over one third of the length of the covering device 1.

The flaps 4 and 20 may have any shape. They can be attached to one another by conventional systems such as staples, self-adhesive strip-type fasteners, or can be sewn together.

According to one particular embodiment of the invention, the covering device 1 is in the form of a triangle with a truncated apex including a rectangular median strip 10 extended laterally by triangular side flaps 20.

The sense of vision is not fully developed the prenatal stage and is in a raw state at birth. In a hospital environment, premature newborns may lack visual stimulation. This deficiency can have long-term consequences on development.

This is why visual stimulation specially adapted to their maturation can help them develop their visual function more easily.

The invention thus also relates to a visual target device 5 adapted to newborns, characterized in that it includes a series of parallel longitudinal strips 50 in different colors.

Such a target device 5 can therefore be made independently of the covering device 1. It can for example be made on the cover of an incubator.

Advantageously, the covering device 1 serves as a support for a visual target device 5 for a newborn to look at.

The visual target device 5 comprises a particular pattern and can be associated with the part of the covering device 1 facing across from the newborn.

The advantage of such a target device 5 is its passive operation type. It allows visual stimulation of the newborn during his awake phases, which are intermittent.

Its regular presence on the covering device 1 allows regular, intermittent stimulation depending on the availability of the child, and not imposed, independently of any action by the caregiving staff.

Another advantage of its presence on the covering device is the ease of removing it when it is necessary to check the newborn through the cover or the upper part of the incubator or to place a care device, for example phototherapy.

Preferably, said target device 5 includes a series of longitudinal strips 50 in the longitudinal direction of said covering device 1, parallel and with different colors.

The different colors can be contrasting.

In general, the strips are designed as parallel lines having contrasting colors to attract newborns' attention.

According to another particular embodiment, said strips 50 have different widths.

According to still another embodiment, said strips 50 and 501 situated in the most median part of said target have a larger width than those 50 and 502 situated on the periphery.

Advantageously, said series of longitudinal strips 50 has a median axis of symmetry oriented along the length of said strips 50.

This particular organization has the advantage of increasing the newborn's interest in the device and fixing his attention more intensely, thus favoring the development of his visual discrimination.

According to one preferred embodiment, the covering device 1 includes means for concealing light, having a wavelength below 650 nm.

Wavelengths above 650 nm comprise the visual light, and above all the ultraviolets, which are particularly dangerous for the retina.

According to one advantageous embodiment, the covering device 1 includes means for filtering soundwaves.

The auditory system of newborns and premature babies is highly sensitive. Means for filtering soundwaves, such as a cellular structure situated in the thickness of the material or a lined and padded material, making up the device 1 allow attenuation of the surrounding noise.

1. A covering device for an incubator for newborns, said covering device comprising: a longitudinal direction wherein one of its ends, in the longitudinal direction, has a width at least two times greater than its width at its opposite end, and wherein at least in the median part of its larger width, it is extended by a longitudinal flap.

2. The covering device, according to claim 1, being symmetrical relative to a longitudinal plane.

3. The covering device, according to claim 1, further comprising: a rectangular median strip, laterally extended at the widest end by side flaps extending at least over one third of the length of the covering device.

4. The covering device, according to claim 1, being in a form of a triangle with a truncated apex and further comprising a rectangular median strip extended laterally by triangular side flaps.

5. The covering device, according to claim 1, serving as a support for a visual target device for a newborn to look at.

6. The covering device, according to claim 5, wherein said target device is comprised of a series of longitudinal strips in the longitudinal direction of said covering device, parallel and with different colors.

7. The covering device, according to claim 6, wherein said strips have different widths.

8. The covering device, according to claim 7, wherein said strips situated in the most median part of said target have a larger width than those situated on the periphery.

9. The covering device, according to claim 1, further comprising: means for concealing light having a wavelength below 650 nm.

10. The covering device, according to claim 1, further comprising: means for filtering soundwaves.
